(19) United States
(12) Patent Application Publication
(10) Pub. No.: US 2005/0228840 A1
(43) Pub. Date: Oct. 13, 2005

(54) Lattice wave digital filter

(75) Inventor: Chom-I Wang, Hsinchu (TW)

Correspondence Address: RATNERPRESTIA, P O BOX 980, VALLEY FORGE, PA, 19482-0980, US

(73) Assignee: BenQ Corporation

(21) Appl. No.: 11/103,200

(22) Filed: Apr. 11, 2005

(30) Foreign Application Priority Data
Apr. 12, 2004 (TW) 93110100

(51) Int. Cl. G06F 17/10

(52) U.S. Cl. 708/318

(57) ABSTRACT

A lattice wave digital filter (LWDF), configured for a digital signal processor having hardware resources, can selectively include a first processing unit or a second processing unit according to the hardware resources. The first processing unit has a single multiplier and the second processing unit has a plurality of multipliers. The circuitry of the LWDF is arranged in such a way that the transmission route from a first input terminal to a first output terminal is as long as the transmission route from a second input terminal to a second output terminal.

### CROSS REFERENCE TO RELATED APPLICATIONS

This Application claims the right of priority based on Taiwan Patent Application No. 0931 10100 entitled “LATTICE WAVE DIGITAL FILTER,” filed on Apr. 12, 2004.

### FIELD OF THE INVENTION

The invention relates to a lattice wave digital filter for use in a digital signal processor.

### BACKGROUND OF THE INVENTION

In current technical field of digital signal processing, a lattice wave digital filter is an important component for performing a transformation function described as follows:
H(z)=1/2(H₁(z)+H₂(z))

According to the transformation function mentioned above, the lattice wave filter needs two all-pass filters to perform H₁(z) and H₂(z), a multiplier to perform 1/2, and an adder. FIGS. 1A and 1B show circuit structures of the lattice wave filter. We can see a first all-pass filter 11, a second all-pass filter 13, an adder 15, and a multiplier 17.

As shown in FIG. 1B, the first all-pass filter 11 and the second all-pass filter both are composed of a plurality of processing unit 19. FIG. 2 shows a circuit structure of a processing unit 19 of prior art. The structure includes a first adder 201, a second adder 203, a third adder 205 and a multiplier 207. FIG. 3 is a state diagram of the processing unit 19 of FIG. 2. As shown in FIG. 2 and FIG. 3, the prior art processing unit 19 includes two input terminals, for inputting a first input signal 200 (state 301) and a second input signal 202 (state 303). The first adder 201 is used for receiving and adding the first input signal 200 and the second input signal 202 to generate a first temporary signal 204 (state 305). The multiplier 207 is used for receiving the first temporary signal 204 and utilizing a predetermined parameter to perform addition to generate a second temporary signal 206 (state 307). The second adder 203 is used for receiving and adding the second input signal 202 and the second temporary signal 206 to generate a second output signal 210 (state 309). The third adder 205 is used for receiving and adding the first temporary signal 204 and the second output signal 210 to generate a first input signal 208 (state 311). The first output signal 208 and the second output signal 210 output through the output terminals of the processing unit 19 to be input signals for the next processing unit. Please note that the parameter of the multiplier 207 changes with the transformation function to be performed.

The circuit structure of the prior art processing unit 19 of (three adders plus a multiplier) cannot adjust according to the hardware resources, which makes it impossible to optimize the resource allocation. Moreover, referring to FIG. 3, the shortest distance of transmission in the prior art processing unit 19 is from state 303 to state 309, and the longest distance is, from state 301 (or 303) to state 305, then 307, 309, 309, and state 311. The great difference between the distances will cause a time lag and further generates a data dependency problem.

### SUMMARY OF THE INVENTION

A lattice wave digital filter for use in a digital signal processor is provided. According to the hardware resources of the digital signal processor, the lattice wave digital filter selectively includes a first processing unit or a second processing unit. The first processing unit only includes one multiplier, while the second processing unit has a plurality of multipliers. More particularly, when the digital signal processor only supports one multiplier, the lattice wave digital filer chooses the first processing unit to perform the transformation function. When the digital signal processor supports a plurality of multipliers, the lattice wave digital filer can choose the first or the second processing unit to perform the transformation function, which results in optimization of the resource allocation.

Besides, the first and the second processing units respectively include a first input terminal and a second input terminal as well as a first output terminal and a second output terminal. The present invention provides a special arrangement of circuitry to make the transmission route of a first input signal from the first input terminal to the first output terminal as long as the transmission route of a second input signal from the second input terminal to the second output terminal. Thus, the data dependency problem can be solved effectively.

### BRIEF DESCRIPTION OF THE DRAWINGS

FIG. 1A is a block diagram of a prior art lattice wave digital filter;

FIG. 1B is a schematic diagram of a prior art lattice wave digital filter;

FIG. 2 is a circuit diagram of a prior art processing unit;

FIG. 3 is a state diagram of a processing unit as shown in FIG. 2;

FIG. 4 is a schematic diagram of a processing unit in accordance with the present invention;

FIG. 5 is a circuit diagram of a first embodiment of the first processing unit;

FIG. 6 is a circuit diagram of a second embodiment of the first processing unit;

FIG. 7 is a circuit diagram of a first embodiment of the second processing unit;

FIG. 8 is a circuit diagram of a second embodiment of the second processing unit; and

FIG. 9 is a schematic diagram of a lattice wave digital filter of the present invention.

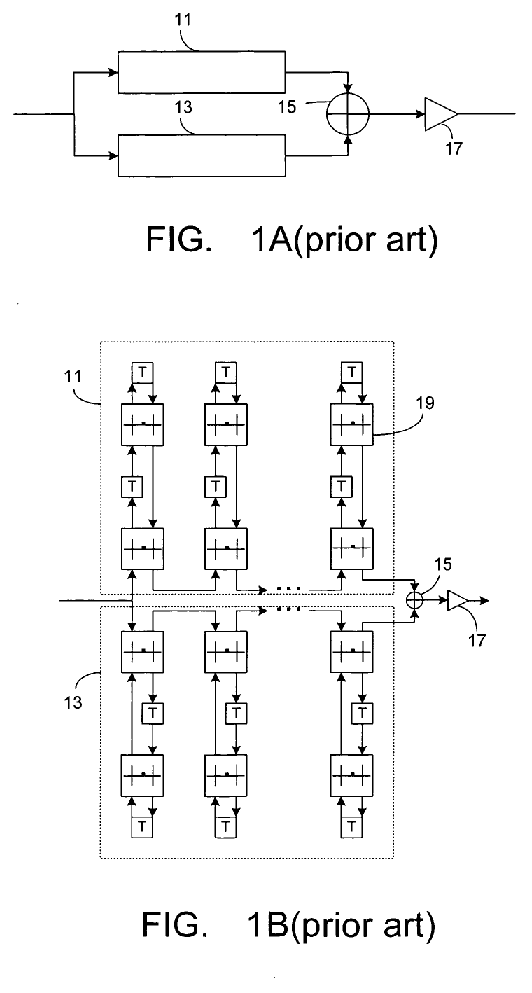

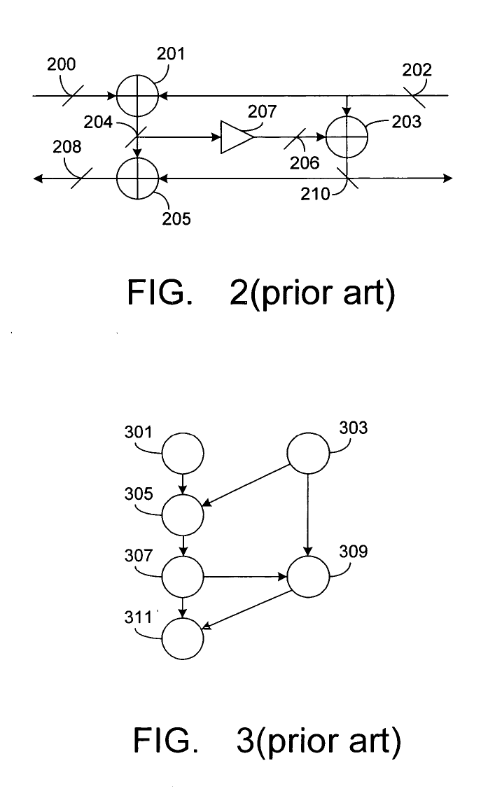

### DETAILED DESCRIPTION OF THE INVENTION

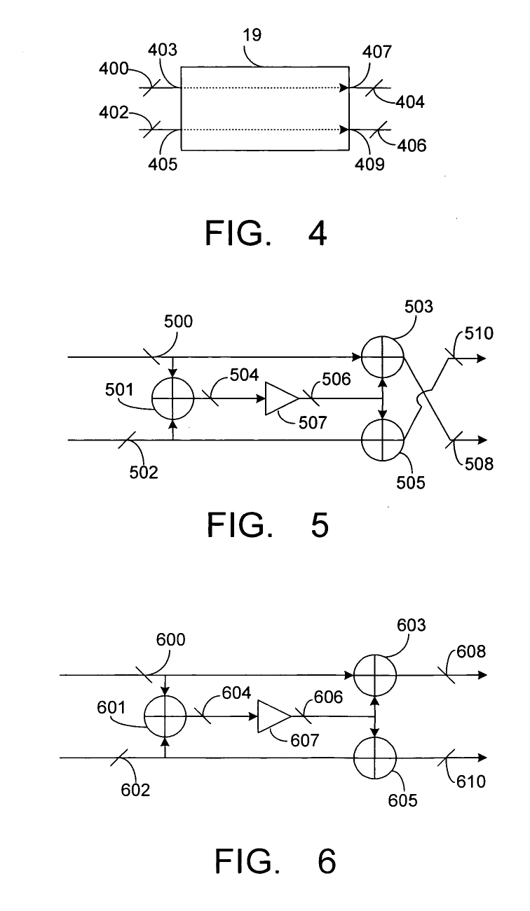

As shown in FIG. 4, the processing unit 19 (namely, the first and the second processing units) includes a first input terminal 403, a second input terminal 405, a first output terminal 407, and a second output terminal 409. The processing unit 19 receives a first input signal 400 and a second input signal 402, after calculating, generating a first output signal 404 and a second output signal 406. The transmission route (shown as a dotted line in the figure) of a first input signal from the first input terminal to the first output terminal is as long as the transmission route (shown as a dotted line in the figure) of a second input signal from the second input terminal to the second output terminal.

The first processing unit includes three adders and one multiplier. The second processing unit includes two adders and four multipliers. These different arrangements enable the lattice wave digital filter to choose the first or the second processing units properly, according to the hardware resources.

The First Processing Unit

As shown in FIG. 5, the first processing unit includes a first adder 501, a second adder 503, a third adder 505, and a multiplier 507. The first adder 501 connects with the first input terminal 403 and the second input terminal 405, for receiving the first input signal 500 (i.e. the first input signal 400 as shown in FIG. 4) and the second input signal 502 (i.e. the second input signal 402 as shown in FIG. 4). After operating an addition by the first adder 501, it generates a first temporary signal 504. The multiplier 507 connects with the first adder 501 for receiving the first temporary signal 504, after a multiplication according to a parameter, generating a second temporary signal 506. The second adder 503 connects with the first input terminal 403 and the multiplier 507, for receiving the first input signal 500 and the second temporary signal 506 to operate the addition and generate a second output signal 508 (i.e. the second output signal 406 as shown in FIG. 4). The third adder 505 connects with the second input terminal 405 and the multiplier 507, for receiving the second input signal 502 and the second temporary signal 506 to operate the addition and generate a first output signal 510 (i.e. the first output signal 404 as shown in FIG. 4). The first output signal 510 outputs through the first output terminal 407 and the second output signal 508 outputs through the second output terminal 409.

Referring to FIG. 6, the second embodiment of the first processing unit includes a first adder 601, a second adder 603, a third adder 605, and a multiplier 607. The first adder 601 connects with the first input terminal 403 and the second input terminal 405 for receiving the first input signal 600 (i.e. the first input signal 400 as shown in FIG. 4) and the second input signal 602 (i.e. the second input signal 402 as shown in FIG. 4) to operate the addition and generate a first temporary signal 604. The multiplier 607 connects with the first adder 601 for receiving the first temporary signal 604, after a multiplication according to a parameter, generating a second temporary signal 606. The second adder 603 connects with the first input terminal 403 and the multiplier 607 for receiving the first input signal 600 and the second temporary signal 606 to operate the addition and generate a second output signal 608 (i.e. the second output signal 406 as shown in FIG. 4). The third adder 605 connects with the second input terminal 405 and the multiplier 607, for receiving the second input signal 602 and the second temporary signal 606 to operate the addition and generate a first output signal 610 (i.e. the second output signal 406 as shown in FIG. 4). The first output signal 608 outputs through the first output terminal 407 and the second output signal 610 outputs through the second output terminal 409.

The Second Processing Unit

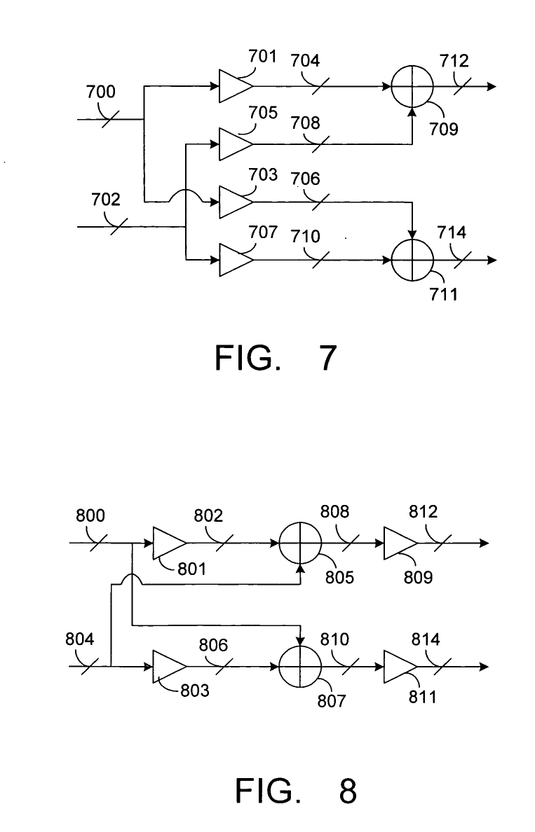

As shown in FIG. 7, the second processing unit includes a first multiplier 701, a second multiplier 703, a third multiplier 705 and a fourth multiplier 707, a first adder 709 and a second adder 700. The first multiplier 701 connects with the first input terminal 403 for receiving the first input signal 700 (i.e. the first input signal 400 as shown in FIG. 4) and, after a multiplication according to a first parameter, generating a first temporary signal 704. The second multiplier 703 also connects with the first input terminal 403 for receiving the first input signal 700 and, after a multiplication according to a second parameter, generating a second temporary signal 706. The third multiplier 705 connects with the second input terminal 405 for receiving the second input signal 702 (i.e. the second input signal 402 as shown in FIG. 4) and, after a multiplication according to a third parameter, generating a third temporary signal 708. The fourth multiplier 707 also connects with the second input terminal 405 for receiving the second input signal 702 and, after a multiplication according to a fourth parameter, generating a fourth temporary signal 710. The first adder 709 connects with the first multiplier 701 and the third multiplier 705 for receiving the first input signal 704 and the third temporary signal 705 to operate the addition and generate a first output signal 712 (i.e. the first output signal 404 as shown in FIG. 4). The second adder 711 connects with the second multiplier 703 and the fourth multiplier 707 for receiving the second temporary signal 706 and the fourth temporary signal 710 to operate the addition and generate a second output signal 714 (i.e. the second output signal 406 as shown in FIG. 4). The first output signal 712 outputs through the first output terminal 407 and the second output signal 714 outputs through the second output terminal 409.

Referring to FIG. 8, the second embodiment of the first processing unit includes a first multiplier 801, a second multiplier 803, a third multiplier 809, a fourth multiplier 811, a first adder 805 and a second adder 807. The first adder 801 connects with the first input terminal 403 for receiving the first input signal 800 (i.e. the first input signal 400 as shown in FIG. 4) to operate the multiplication according to a first parameter and generate a first temporary signal 802. The second multiplier 803 connects with the second input terminal 405 for receiving the second input signal 804 (i.e. the second input signal 402 as shown in FIG. 4) to operate the multiplication according to a second parameter and generate a second temporary signal 806. The first adder 805 connects with the first multiplier 801 and the second input terminal 405 for receiving the first temporary signal 802 and the second input signal 804 to operate the addition and generate a third temporary signal 808. The second adder 807 connects with the second multiplier 803 and the first input terminal 403 for receiving the second temporary signal 806 and the first input signal 800 to operate the addition and generate a fourth temporary signal 810. The third multiplier 809 connects with the first adder 805 for receiving the third temporary signal 808 and, after a multiplication according to a third parameter, generating a first output signal 812 (i.e. the first output signal 404 as shown in FIG. 4). The fourth multiplier 811 connects with the second adder 807 for receiving the fourth temporary signal 811 and, after a multiplication according to a fourth parameter, generating a second output signal 814 (i.e. the second output signal 406 as shown in FIG. 4). The first output signal 812 outputs through the first output terminal 407 and the second output signal 814 outputs through the second output terminal 409.

Referring to FIGS. 5-8, the circuit structures of the embodiments are conspicuously symmetrical. Thus, the transmission route of a first input signal 400 from the first input terminal 403 to the first output terminal 407 is as long as the transmission route of a second input signal 402 from the second input terminal 405 to the second output terminal 409. Due to the same distance of the two transmission routes, the data dependency problem can be solved.

Thus, when the lattice wave digital filter of the present invention chooses a first processing unit or a second processing unit according to the hardware resources, the first and the second all-pass filters of the lattice wave digital filter utilize the same (chosen) first processing unit or second processing unit. Thus, the symmetry of the first and the second filters is enhanced to further reduce data dependency.

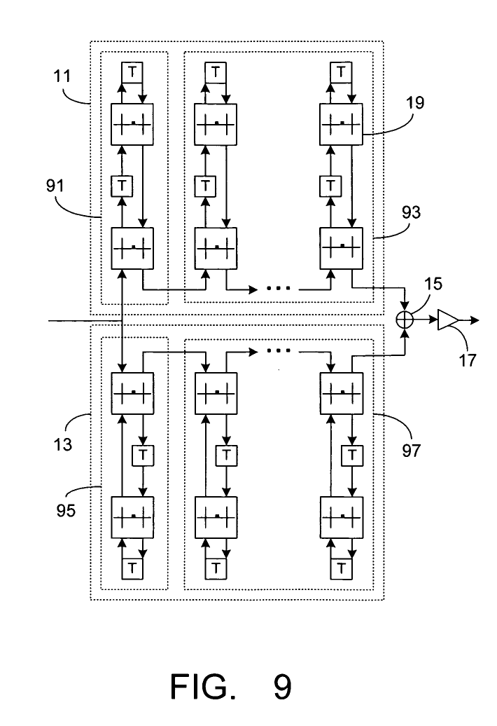

More particularly, if the hardware resources are sufficient, the first and the second all-pass filters can partially utilize the first processing unit and partially utilize the second processing unit. As shown in FIG. 9, the first all-pass filter 11 includes a first circuit 91 and a second circuit 93. The second all-pass filter 13 includes a third circuit 95 and a fourth circuit 97. The first circuit 91 corresponds to the third circuit 95; they have the same structures and the same number of processing units. The first circuit 91 and the third circuit 93 selectively include the first processing unit and the second processing unit. The second circuit 93 corresponds to the fourth circuit 97; they have the same structures and the same number of processing units. The second circuit 93 and the fourth circuit 97 selectively include the first processing unit and the second processing unit. Thus, the first circuit 91 and the third circuit 95 are symmetrical to each other, and the second circuit 93 and the fourth circuit 97 are symmetrical to each other. Please note that the processing units in the first circuit 91 (or the third circuit 95) are not necessary to be the same as the processing units in the second circuit 93 (or the third circuit 95), and the discriminating method of circuits 91, 93, 95, 97 as shown in this embodiment is not limited.

While the invention has been described in connection with what is presently considered to be the most practical and preferred embodiments, it is to be understood that the invention is not to be limited to the discovered embodiments. The invention is intended to cover various modifications and equivalent arrangements included within the spirit and scope of the appended claims.

1. A lattice wave digital filter for using in a digital signal processor having hardware resources, the lattice wave digital filter selectively comprising one of a first processing unit and a second processing unit according to the hardware resources; wherein the first processing unit has a multiplier and the second multiplier has a plurality of multipliers.

2. The lattice wave digital filter according to claim 1, wherein the first processing unit comprising:
a first input terminal;
a second input terminal;
a first output terminal; and
a second output terminal;
wherein the transmission route of a first input signal from the first input terminal to the first output terminal is as long as the transmission route of a second input signal from the second input terminal to the second output terminal.

3. The lattice wave digital filter according to claim 2, wherein the first processing unit further comprises:
a first adder connected with the first input terminal and the second input terminal for adding the first input signal and the second input signal and generating a first temporary signal;
a multiplier connected with the first adder for multiplying the first temporary signal and a parameter and generating a second temporary signal;
a second adder connected with the first input terminal and the multiplier for adding the first input signal and the second temporary signal and generating a second output signal; and
a third adder connected with the second input terminal and the multiplier for adding the second input signal and the second temporary signal and generating a first output signal;
wherein the first output signal outputs through the first output terminal and the second output signal outputs through the second output terminal.

4. The lattice wave digital filter according to claim 2, wherein the first processing unit further comprises:
a first adder connected with the first input terminal and the second input terminal for adding the first input signal and the second input signal and generating a first temporary signal;.
a multiplier connected with the first adder for multiplying the first temporary signal and a parameter and generating a second temporary signal;
a second adder connected with the first input terminal and the multiplier for adding the first input signal and the second temporary signal and generating a first output signal; and
a third adder connected with the second input terminal and the multiplier for adding the second input signal and the second temporary signal and generating a second output signal;
wherein the first output signal outputs through the first output terminal and the second output signal outputs through the second output terminal.

5. The lattice wave digital filter according to claim 1, wherein the second processing unit comprising:
a first input terminal;
a second input terminal;
a first output terminal; and
a second output terminal;
wherein the transmission route of a first input signal from the first input terminal to the first output terminal is as long as the transmission route of a second input signal from the second input terminal to the second output terminal.

6. The lattice wave digital filter according to claim 5, wherein the second processing unit further comprises:
a first multiplier connected with the first input terminal for multiplying the first input signal and a first parameter and generating a first temporary signal;
a second multiplier connected with the first input terminal for multiplying the first input signal and a second parameter and generating a second temporary signal;
a third multiplier connected with the second input terminal for multiplying the second input signal and a third parameter and generating a third temporary signal;
a fourth multiplier connected with the second input terminal for multiplying the second input signal and a fourth parameter and generating a fourth temporary signal;
a first adder connected with the first multiplier and the third multiplier for adding the first temporary signal and the third temporary signal and generating a first output signal; and
a second adder connected with the second multiplier and the fourth multiplier for adding the second temporary signal and the fourth temporary signal and generating a second output signal;
wherein the first output signal outputs through the first output terminal and the second output signal outputs through the second output terminal.

7. The lattice wave digital filter according to claim 5, wherein the second processing unit further comprises:
a first multiplier connected with the first input terminal for multiplying the first input signal and a first parameter and generating a first temporary signal;
a second multiplier connected with the second input terminal for multiplying the second input signal and a second parameter and generating a second temporary signal;
a first adder connected with the first multiplier and the second multiplier for adding the first temporary signal and the second input signal and generating a third temporary signal;
a second adder connected with the second multiplier and the first input terminal for adding the second temporary signal and the first input signal and generating a third temporary signal;
a third multiplier connected with the second input terminal for multiplying the second input signal and a third parameter and generating a third temporary signal; and
a fourth multiplier connected with the first adder for multiplying the third temporary signal and a third parameter and generating a first output signal;
wherein the first output signal outputs through the first output terminal and the second output signal outputs through the second output terminal.

8. The lattice wave digital filter according to claim 1, further comprising:
a first all-pass filter, having a first circuit and a second circuit; and
a second all-pass filter, having a third circuit and a fourth circuit;
wherein, the first circuit corresponds to the third circuit and selectively includes one of the first processing unit and the second processing unit, and the second circuit corresponds to the fourth circuit and selectively includes one of the first processing unit and the second processing unit.

9. A lattice wave digital filter using in a digital signal processor having hardware resources, the lattice wave digital filter comprising:
a first all-pass filter having a first circuit and a second circuit; and
a second all-pass filter having a third circuit and a fourth circuit;
wherein, the lattice wave digital filter selectively includes one of a first processing unit and a second processing unit according to the hardware resources, and the first processing unit has a multiplier and the second multiplier has four multipliers, and the first circuit corresponds to the third circuit and selectively includes one of the first processing unit and the second processing unit, and the second circuit corresponds to the fourth circuit and selectively includes one of the first processing unit and the second processing unit.

10. The lattice wave digital filter according to claim 9, wherein the first processing unit comprising:
a first input terminal;
a second input terminal;
a first output terminal; and
a second output terminal;
wherein the transmission route of a first input signal from the first input terminal to the first output terminal is as long as the transmission route of a second input signal from the second input terminal to the second output terminal.

11. The lattice wave digital filter according to claim 10, wherein the first processing unit further comprises:
a first adder connected with the first input terminal and the second input terminal for adding the first input signal and the second input signal and generating a first temporary signal;
a multiplier connected with the first adder for multiplying the first temporary signal and a parameter and generating a second temporary signal;
a second adder connected with the first input terminal and the multiplier for adding the first input signal and the second temporary signal and generating a second output signal; and
a third adder connected with the second input terminal and the multiplier for adding the second input signal and the second temporary signal and generating a first output signal;
wherein, the first output signal outputs through the first output terminal and the second output signal outputs through the second output terminal.

12. The lattice wave digital filter according to claim 10, wherein the first processing unit further comprises:
a first adder connected with the first input terminal and the second input terminal for adding the first input signal and the second input signal and generating a first temporary signal;
a multiplier connected with the first adder for multiplying the first temporary signal and a parameter and generating a second temporary signal;
a second adder connected with the first input terminal and the multiplier for adding the first input signal and the second temporary signal and generating a first output signal; and
a third adder connected with the second input terminal and the multiplier for adding the second input signal and the second temporary signal and generating a second output signal;
wherein the first output signal outputs through the first output terminal and the second output signal outputs through the second output terminal.

13. The lattice wave digital filter according to claim 9, wherein the second processing unit comprising:
a first input terminal;
a second input terminal;
a first output terminal; and
a second output terminal;
wherein the transmission route of a first input signal from the first input terminal to the first output terminal is as long as the transmission route of a second input signal from the second input terminal to the second output terminal.

14. The lattice wave digital filter according to claim 13, wherein the second processing unit further comprises:
a first multiplier connected with the first input terminal for multiplying the first input signal and a first parameter and generating a first temporary signal;
a second multiplier connected with the first input terminal for multiplying the first input signal and a second parameter and generating a second temporary signal;
a third multiplier connected with the second input terminal for multiplying the second input signal and a third parameter and generating a third temporary signal;
a fourth multiplier connected with the second input terminal for multiplying the second input signal and a fourth parameter and generating a fourth temporary signal;
a first adder connected with the first multiplier and the third multiplier for adding the first temporary signal and the third temporary signal and generating a first output signal; and
a second adder connected with the second multiplier and the fourth multiplier for adding the second temporary signal and the fourth temporary signal and generating a second output signal;
wherein the first output signal outputs through the first output terminal and the second output signal outputs through the second output terminal.

15. The lattice wave digital filter according to claim 13, wherein the second processing unit further comprises:
a first multiplier connected with the first input terminal for multiplying the first input signal and a first parameter and generating a first temporary signal;
a second multiplier connected with the second input terminal for multiplying the second input signal and a second parameter and generating a second temporary signal;
a first adder connected with the first multiplier and the second multiplier for adding the first temporary signal and the second input signal and generating a third temporary signal;
a second adder connected with the second multiplier and the first input terminal for adding the second temporary signal and the first input signal and generating a third temporary signal;
a third multiplier connected with the second input terminal for multiplying the second input signal and a third parameter and generating a third temporary signal; and
a fourth multiplier connected with the first adder for multiplying the third temporary signal and a third parameter and generating a first output signal;
wherein the first output signal outputs through the first output terminal and the second output signal outputs through the second output terminal.

16. A lattice wave digital filter using in a digital signal processor having hardware resources, the lattice wave digital filter comprising:
a first all-pass filter, having a first circuit and a second circuit; and
a second all-pass filter, having a third circuit and a fourth circuit;
wherein, the lattice wave digital filter selectively includes one of a first processing unit and a second processing unit according to the hardware resources, the first circuit corresponds to the third circuit and selectively includes one of the first processing unit and the second processing unit, and the second circuit corresponds to the fourth circuit and selectively includes one of the first processing unit and the second processing unit;
wherein, the first processing unit has a multiplier and the second multiplier has four multipliers, and the first processing unit and the second processing unit respectively include a first input terminal, a second input terminal, a first output terminal and a second output terminal, and the transmission route of a first input signal from the first input terminal to the first output terminal is as long as the transmission route of a second input signal from the second input terminal to the second output terminal.

17. The lattice wave digital filter according to claim 16, wherein the first processing unit further comprises:
a first adder connected with the first input terminal and the second input terminal for adding the first input signal and the second input signal and generating a first temporary signal;
a multiplier connected with the first adder for multiplying the first temporary signal and a parameter and generating a second temporary signal;
a second adder connected with the first input terminal and the multiplier for adding the first input signal and the second temporary signal and generating a second output signal; and
a third adder connected with the second input terminal and the multiplier for adding the second input signal and the second temporary signal and generating a first output signal;
wherein, the first output signal outputs through the first output terminal and the second output signal outputs through the second output terminal.

18. The lattice wave digital filter according to claim 16, wherein the first processing unit further comprises:
a first adder connected with the first input terminal and the second input terminal for adding the first input signal and the second input signal and generating a first temporary signal;
a multiplier connected with the first adder for multiplying the first temporary signal and a parameter and generating a second temporary signal;
a second adder connected with the first input terminal and the multiplier for adding the first input signal and the second temporary signal and generating a first output signal; and
a third adder connected with the second input terminal and the multiplier for adding the second input signal and the second temporary signal and generating a second output signal;
wherein the first output signal outputs through the first output terminal and the second output signal outputs through the second output terminal.

19. The lattice wave digital filter according to claim 16 wherein the second processing unit further comprises:
a first multiplier connected with the first input terminal for multiplying the first input signal and a first parameter and generating a first temporary signal;
a second multiplier connected with the first input terminal for multiplying the first input signal and a second parameter and generating a second temporary signal;
a third multiplier connected with the second input terminal for multiplying the second input signal and a third parameter and generating a third temporary signal;
a fourth multiplier connected with the second input terminal for multiplying the second input signal and a fourth parameter and generating a fourth temporary signal;
a first adder connected with the first multiplier and the third multiplier for adding the first temporary signal and the third temporary signal and generating a first output signal; and
a second adder connected with the second multiplier and the fourth multiplier for adding the second temporary signal and the fourth temporary signal and generating a second output signal;
wherein the first output signal outputs through the first output terminal and the second output signal outputs through the second output terminal.

20. The lattice wave digital filter according to claim 16 wherein the second processing unit further comprises:
a first multiplier connected with the first input terminal for multiplying the first input signal and a first parameter and generating a first temporary signal;
a second multiplier connected with the second input terminal for multiplying the second input signal and a second parameter and generating a second temporary signal;
a first adder connected with the first multiplier and the second multiplier for adding the first temporary signal and the second input signal and generating a third temporary signal;
a second adder connected with the second multiplier and the first input terminal for adding the second temporary signal and the first input signal and generating a third temporary signal;
a third multiplier connected with the second input terminal for multiplying the second input signal and a third parameter and generating a third temporary signal; and
a fourth multiplier connected with the first adder for multiplying the third temporary signal and a third parameter and generating a first output signal;
wherein the first output signal outputs through the first output terminal and the second output signal outputs through the second output terminal.
